(19) United States
(12) Patent Application Publication
(10) Pub. No.: US 2015/0371094 A1
(43) Pub. Date: Dec. 24, 2015

(54) A ROAD MARKING ANALYSER AND A METHOD OF ANALYSIS OF ROAD MARKINGS AND AN APPARATUS AND METHOD FOR DETECTING VEHICLE WEAVE

(71) Applicant: W.D.M. LIMITED, Bristol, Avon (GB)

(72) Inventors: John Leslie GARDINER, Bristol (GB); Richard Dal LAGO, Bristol (GB)

(73) Assignee: W.D.M. LIMITED, Bristol (GB)

(21) Appl. No.: 14/764,245

(22) PCT Filed: Jan. 24, 2014
(86) PCT No.: PCT/GB2014/050187

§ 371 Date: Jul. 29, 2015

(30) Foreign Application Priority Data
Feb. 13, 2013 (GB) 1302538.2

(51) Int. Cl. G06K 9/00; G01S 19/13; H04N 5/222

(52) U.S. Cl. CPC G06K 9/00798; H04N 5/222; G06K 9/00825; G01S 19/13

(57) ABSTRACT

An apparatus is provided that is operable as a road marking analyser, comprising a light source arranged to illuminate a road, a camera directed or arranged to view vertically downward in a direction substantially perpendicular to a surface of the road and arranged to capture an image of one or more road markings on the road and a processor arranged to output the captured image to a memory and/or process the image to determine a condition of the one or more road markings.

### FIELD OF THE INVENTION

This invention relates to a road marking analyser and a method of analysis of road markings, and to detecting vehicle weave.

### BACKGROUND TO THE INVENTION

As of January 2013, there is widespread concern about the condition of road markings on European roads. For instance, according to the Road Safety Markings Association, 24% of road markings in the United Kingdom are in need of immediate replacement.

Currently, the condition of road markings on roads and carriageways may be assessed using two methods. One method involves the performance of manual site inspections in which a worker physically examines the conditions of road markings with the naked eye. This process is time consuming and expensive, and uses up valuable man hours. The process is also subjective. An alternative method is to measure the retro-reflectivity of road markings using a forward facing light source and corresponding detector to measure reflectivity of the road markings from the perspective of a road user. However, retro-reflectivity values collected from such surveys can be misleading of the actual quality and condition of the road markings and thus do not always provide an accurate assessment.

### SUMMARY OF THE INVENTION

According to a first aspect of the invention, there is provided a road marking analyser comprising: a light source arranged to illuminate a road; a camera directed or arranged to view vertically downward in a direction substantially perpendicular to a surface of the road and arranged to capture an image of one or more road markings on the road; and a processor arranged to output the captured image to a memory and/or process the image to determine a condition of the one or more road markings. This may be done by forming measurements of luminance or brightness of the one or more road markings.

Because the camera is directed or views vertically downward in a direction substantially perpendicular to the road surface, a plan view image of any road markings can be acquired. Thus damage to a road marking, which may not be made out by prior art forward facing retro-reflectivity detectors, can be detected and analysed. A more accurate assessment of the condition of road markings can be attained, thereby providing earlier warning of the requirement for replacement or renewal of road markings.

The light source may be a visible light or infra red scanning laser source and may be arranged to illuminate the road with a known and constant luminance, thus maximising accuracy and repeatability of results.

The camera may be a area view camera viewing a two dimensional area of the road. Alternatively the camera may be a line scan camera having a single line of pixels. If a scanning laser source is used as the light source, the single line of pixels may be in line with the scan of the laser. Each pixel of the line scan camera may comprise a photodiode. At its simplest, the line scan camera may comprise a single photodiode.

The road marking analyser may be provided in combination with a vehicle. In which case, the vehicle may be arranged to carry the road marking analyser. The vehicle may be a car, van or lorry or other suitable vehicle arranged to travel along a road. Alternatively or additionally, the vehicle may be arranged to travel on other surfaces, for instance an aircraft runway or a running track.

The road marking analyser may comprise a device such as a speedometer arranged to measure the speed of the vehicle. The speed of the vehicle at the time at which the camera captures an image may be stored in the memory. Thus, where the camera is a line scan camera, dimensions of the road in the captured image may be calculated as a function of the vehicle speed over the road.

The processor may be arranged to detect road markings in the image captured by the camera. This may be achieved by dividing the image representing a portion of a road into a plurality of columns orientated parallel to the direction of travel of the vehicle. A value of luminance, brightness or another characteristic may be calculated for each of the plurality of columns. Changes in the calculated values may then be identified such that the edges of each of the one or more road markings may be detected.

The processor may generate measurements of brightness or luminance or other characteristics of the one or more road markings identified in the captured image. This process may be performed on each of the pixels of the identified road markings or on regions of the image. The value of each pixel or region may be compared with a predetermined threshold value. Generated measurements may be stored in the memory or transmitted via an input/output device to a remote location. The input/output device may be integral to the road marking analyser or may be separate.

The identified road markings may be compared with a set of road markings stored in a database of road markings. The database may be specific to the location of the road at which the image was captured. The processor may then determine the types of the one or more road markings based on the comparison against those stored in the database. The shape of the actual road marking may then be analysed to see how much of the marking has been worn away. Comparisons may be made with a previous survey in order to estimate how rapidly a marking is degrading.

The road marking analyser may further comprise a GPS receiver which may receive a location of the road marking analyser. When performing the comparison, the database may contain or present a reduced subset of road markings depending on the location of the road marking analyser, thus reducing the time required to search through the database for a match between the actual road markings and the reduced subset.

The road marking analyser may be adapted to predict the potential location of a road marking in the captured image based on the location information from the GPS receiver, such that the processor knows where in the image to expect a road marking. Such functionality may be implemented in conjunction with providing a reduced subset of road markings in the database.

The captured image and any information extracted by the processor may be transmitted via the input/output device to a remote location for analysis and/or post processing.

In accordance with a second aspect of the invention, there is provided a method of analysing road markings, comprising while travelling along a road in a vehicle, illuminating one or more road markings, capturing an image of the one or more road markings with a camera, the camera directed vertically downward substantially perpendicular to the surface of the road, and storing the captured image of the one or more road markings or processing the captured image to determine the condition of the one or more road markings.

In accordance with a third aspect of the invention, there is provided a vehicle weave detector, comprising a light source arranged to illuminate a road, and a detector having a field of view directed vertically downward in a direction substantially perpendicular to a surface of the road and arranged to capture reflected light from the road, and a processor arranged to: generate images of the road from the reflected light; detect a position of one or more elongate road markings in each image; and compare the position of the one or more road markings in subsequent images to generate a measure of weave of a vehicle relative to the road.

Thus, information concerning a driver's weave along a road may be collected and used to determine the quality of a person's driving. Such information may be used to analyse the state of a driver, which may include determining whether a driver is tired or intoxicated. Vehicle weave information may be used to develop a profile of a particular driver and his habits. Such information may be of particular value to insurance companies when assessing the safety of an insured driver and the risk of accident posed by that driver.

A comparison of the positions of the edges of the one or more road markings in subsequent images may then attained to determine a relative displacement of the vehicle in a direction perpendicular to the direction of travel of the vehicle. Thus the driver's weave, i.e. steering left or right relative to the one or more road markings, may be detected.

Captured images and any information extracted by the processor may be transmitted via the input/output device to a remote location for analysis and/or post processing.

Because the detector is directed or views vertically downward in a direction substantially perpendicular to the road surface, a plan view image of any road markings can be acquired. By assuming that a road line or marking follows the path of a road, an estimate of a driver's directional control of a vehicle can be formed.

The light source may be a visible light or infra red scanning laser source and may be arranged to illuminate the road with a known and constant luminance, thus maximising accuracy and repeatability of results.

The camera may be an area view camera viewing a two dimensional area of the road. Alternatively the camera may be a line scan camera having a single line of pixels. If a scanning laser source is used as the light source, the single line of pixels may be in line with the scan of the laser. Each pixel of the line scan camera may comprise a photodiode. At its simplest, the line scan camera may comprise a single photodiode.

The vehicle weave detector may be provided in combination with a vehicle. The vehicle may be arranged to carry the weave detector. The vehicle may be a car, van or lorry or other suitable vehicle arranged to travel along a road. Alternatively or additionally, the vehicle may be arranged to travel on other surfaces, for instance an aircraft runway or a running track.

The vehicle weave detector may comprise a device such as a speedometer arranged to measure the speed of the vehicle. The speed of the vehicle at the time at which the camera captures an image may be stored in the memory. Thus, where the camera is a line scan camera, dimensions of the road in the captured image may be calculated as a function of the vehicle speed over the road. This can be used to judge an amount of meander or weave in the vehicle's path with respect to the road or carriageway.

The processor may be arranged to detect road markings in the image captured by the camera. This may be achieved by dividing the image representing a portion of a road into a plurality of columns orientated parallel to the direction of travel of the vehicle. A value of luminance, brightness or another characteristic may be calculated for each of the plurality of columns. Changes in the calculated values may then be identified such that the edges of each of the one or more road markings may be detected.

Information concerning a driver's weave along a road may be collected and used to determine the quality of a person's driving. For example, a comparison of the positions of the edges of the one or more road markings in subsequent images may be attained to determine a relative displacement of the vehicle in a direction perpendicular to the direction of travel of the vehicle. Thus the driver's weave, i.e. steering left or right relative to the one or more road markings, may be detected.

Such information may be used to analyse the state of a driver, which may include determining whether a driver is tired or intoxicated. Vehicle weave information may be used to develop a profile of a particular driver and his habits. Such information may be of particular value to insurance companies when assessing the safety of an insured driver and the risk of accident posed by that driver. Such information may be made available by an output device in the vehicle or sent to another location (for example wirelessly) for analysis.

The vehicle weave detector may further comprise a GPS receiver which may receive a location of the vehicle weave detector. This can avoid the weave detector giving false indications of weaving when a road marking is not available, or the vehicle is at a junction or similar location at which a change of direction is required.

According to a further aspect of the invention, there is provided a method of detecting vehicle weave, comprising: while travelling along a road in a vehicle, illuminating a road; capturing reflected light from the one or more road markings with a detector, the detector directed vertically downward in a direction substantially perpendicular to a surface of the road; generating images of the road from the reflected light; detecting a position of one or more road markings in each image; and comparing the position of the one or more road markings in subsequent images to generate a measure of weave of a vehicle relative to the road.

### BRIEF DESCRIPTION OF THE DRAWINGS

Embodiments of the present invention will now be described, by non-limiting example only, with reference to the accompanying drawings, in which:

FIG. 1 is a side view of a vehicle comprising an apparatus operable as a road marking analyser, and/or as a vehicle weave detector;

FIG. 2 is a rear view of the vehicle of FIG. 1;

FIG. 3 is an example image captured by the apparatus of FIG. 1;

FIG. 4 is an example image taken from a front facing camera;

FIG. 5 is a schematic diagram of an apparatus operable as a road marking analyser and/or a vehicle weave detector;

FIG. 6 is a simplified representation of the image shown in FIG. 3;

FIG. 7 is a flow chart showing the steps of processing an image captured by a road marking analyser or vehicle weave detector;

FIG. 8 is a further simplified representation of the image shown in FIG. 3 in which road marking in the image is worn; and

FIGS. 9a to 9f show examples of road markings which may be analysed by road marking analysers and/or vehicle weave detectors.

### DESCRIPTION OF EMBODIMENTS OF THE INVENTION

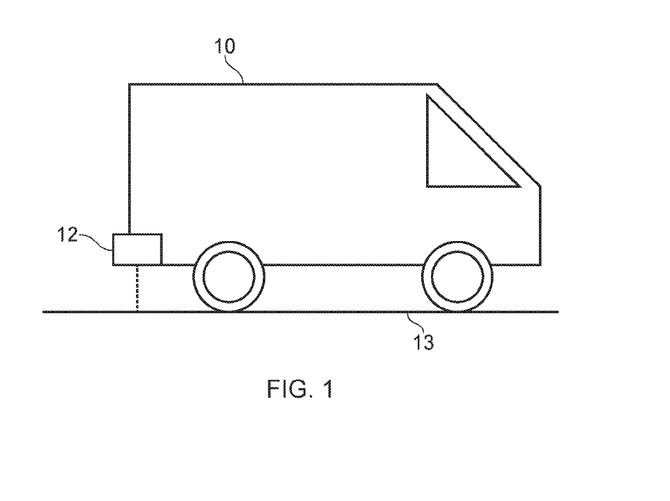

FIG. 1 shows a vehicle 10 carrying an apparatus 12 operable as a road marking analyser or as a vehicle weave detector that determines weave by analysing a vehicle path compared to road markings such as lines on a road or carriageway 13. The vehicle 10 may be any vehicle suitable to travel over the road or carriageway 13, for example a car, van or lorry. During operation, the vehicle may drive along a road or carriageway 13 thus passing over various road markings such as road lines, arrows, hashings and stop or give way signs marked on the road by way of white or coloured reflective paint.

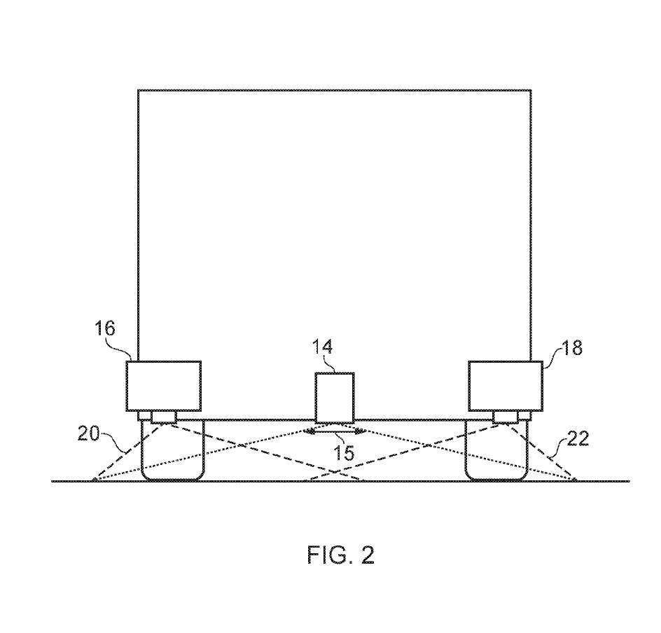

Referring now to FIG. 2, the apparatus 12 may comprise a light source 14 which in the embodiment shown is a scanning laser but may alternatively be, for example, a fluorescent light tube or any other light source known in the art. The scanning laser 14 is arranged to raster along an axis perpendicular to the direction of travel of the vehicle 10, as denoted by arrow 15. Thus, the scanning laser 14 provides a monochromatic illumination of constant intensity, independent of natural illumination. This allows repeatable image properties to be obtained from captured images of illuminated road markings on the surface of the road 13. The light source 14 may be a visible light source or an infra red light source.

The apparatus 12 further comprises one or more cameras 16, 18 directed vertically downward from the vehicle 10 in a direction substantially perpendicular to the surface of the road 13 upon which the vehicle 10 is travelling. Depending on the light source used to illuminate the road 13, the one or more cameras 16, 18 may be visible light cameras or infra red cameras. Equally, whilst the invention will be described herein using cameras to image to road surface, infra red or visible light photodiodes may be used in their place, depending on the image resolution required for a particular application, and the illumination source used. It will be appreciated that the term “camera” used herein encompasses any electronic device capable of receiving and processing light signals.

The cameras 16, 18 have an optical axis substantially perpendicular to the incident road surface. Most roads and carriageways exhibit a camber to promote drainage toward the edge of the road 13. Accordingly, it will be appreciated that due to such camber, the cameras 16, 18 may not be directed directly downward at all times. The camera or cameras 16, 18 are arranged to collect reflected light from the road and thus images of the road and any road markings situated thereon. The camera(s) may be an area view camera adapted to capture a two dimensional view of the road. Alternatively the camera may be a line scan camera having a single line of pixels. If a scanning laser is used as the light source 14, the single line of pixels may be in line with the scan of the laser. Each pixel of the line scan camera may comprise a photodiode. At its simplest, the line scan camera may comprise a single photodiode. The combined field of view of the one or more cameras 16, 18 in a road marking analyser preferably extends across the entire width of the vehicle 10 and more preferably a span which should encompass at least one lane of a road being imaged. Dashed lines 20 and 22 in FIG. 2 denote an example field of view of the cameras 16, 18, respectively. In embodiments where more than one camera is used, such as that shown in FIG. 2, it will be appreciated that fields of view of each of the cameras 16, 18 may overlap. Where a plurality of cameras 16, 18 are used, the images collected by the cameras 16, 18 may be combined to provide a single image covering the field of the view of both of the cameras 16, 18, using any known method. Equally, subsequent images captured by the one or more cameras 16, 18 may be combined together to form an image covering a larger length of the carriageway than that covered by a single image (i.e. in a direction of travel of the vehicle). The one or more cameras 16, 18 may image the strip of road being illuminated, each consecutive image strip being combined with the previous captured strip to form a image of the length of the road surface 13. The method is particularly applicable where the road is illuminated using a raster scanning laser and imaged using a line scan camera, as described above. In some circumstances, the position of a road marking on a road can be estimated. For example, a road line is likely to be positioned along the edge of a road or along the middle of the road demarking a carriageway or lane. In such circumstances, the camera(s) 16, 18 may image only that part of the road in which it is estimate that a road marking is positioned.

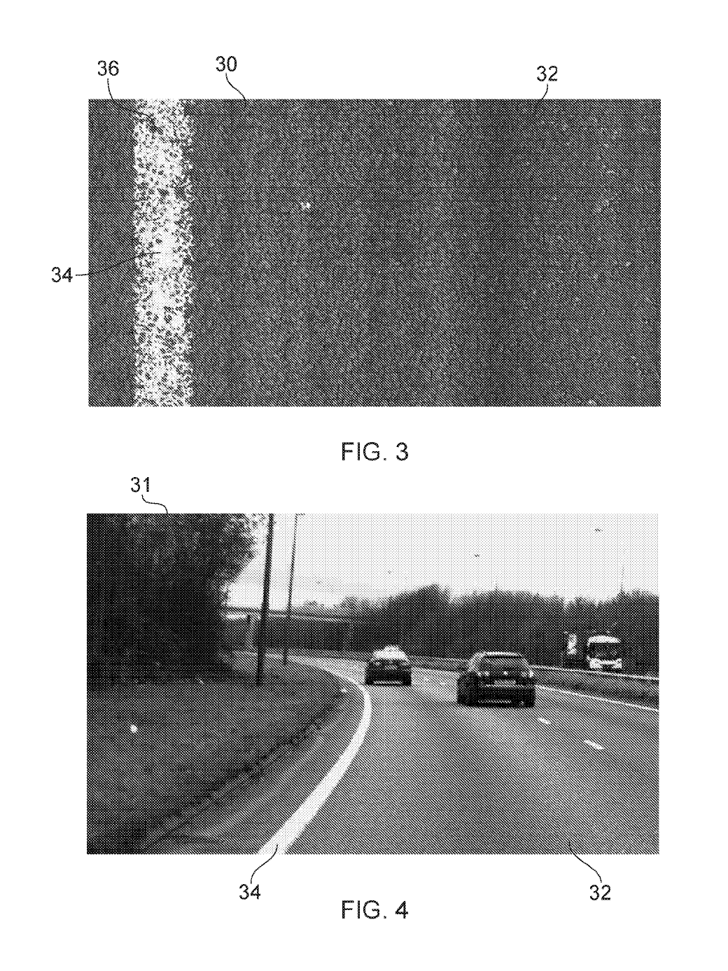

The arrangement of the scanning laser 14 and the cameras 16, 18 enables images of road markings on the road 13 to be collected which provide information concerning the position and condition of the road markings in addition to the road surface itself. Because the one or more cameras 16, 18 are directed vertically downward in relation to the vehicle 10, a plan view of such road markings can be acquired. FIG. 3 shows an example image acquired by an apparatus operable as a road marking analyser and/or a vehicle weave detector. The image 30 shows a road 32 upon which is marked a white line 34. As mentioned above, the image 30 is taken from a position directly above the road surface so as to provide a plan view of the road surface and any markings thereof. As can be seen from the image 30, there is substantial wear to the white line 34 on the road surface such that much of the white paint has been worn down to such an extent that parts of the road surface 36 are now showing through the road marking 34. FIG. 4 shows an image 31 of the same stretch of road 32 captured using a forward facing camera. As can be seen, the white line 34 seems from this image to be completely intact and thus in good condition. However, the perceived condition of the white line when viewed with the forward facing image 31 is not representative of the actual condition of the white line 34, clearly illustrated by image 30 from the downward facing cameras 16, 18.

As mentioned above, prior art methods of road marking surveying using forward facing cameras and retro reflectivity readings have exactly this disadvantage. A forward facing detector provides a misleading representation of the condition of road markings on a road. As such, road markings in need of replacement are often not identified until they are severely damaged and in some circumstances almost completely worn off the road. Since in the embodiments of the present invention cameras or detectors are directed vertically downwards (i.e. not forward or backward looking), an accurate picture of the condition of the road marking can be acquired and analysed so as to provide a comprehensive assessment of the quality of road markings in a time and cost efficient manner.

Another advantage of a downward looking camera is that the position of a road marking relative to the vehicle can be monitored more accurately than if the camera(s) were directed forward, collecting an image as shown in FIG. 4. Comparing images 3 and 4, the white line in image 3 occupies a greater portion of the image, and due to the direct vertical view changes in ride height due to compliance of the vehicle suspension have a much less significant effect in image of FIG. 3 compared to the image of FIG. 4. Additionally, image interference which may be created by headlights of oncoming traffic, rain, surface water and other sources of interference, is reduced by directing the camera(s) 16, 18 downwards.

The condition of the road marking may be estimated and be used as a metric to determine how accurate a given measure of weave is. For example, the condition of the road marking may be stored and/or analysed in real time or post event to determine whether a measure of weave measured by the detector is an accurate assessment of vehicle weave.

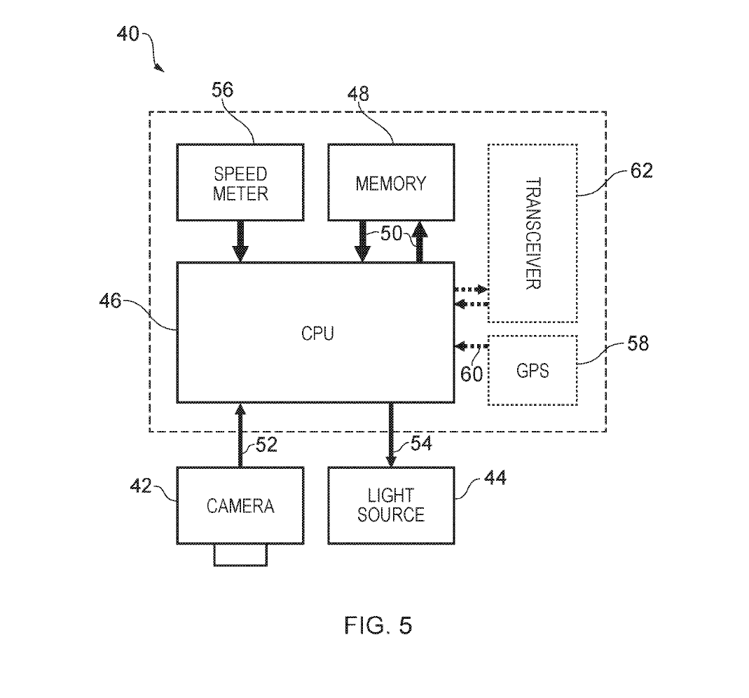

Referring now to FIG. 5, a road marking analyser (or weave detector) 40 is shown. The road marking analyser 40 comprises one or more cameras 42 and a light source 44 which may be equivalent to the one or more cameras 16, 18, and scanning laser 14 shown in FIG. 2, respectively. Whilst a single camera is drawn in the schematic diagram, it will be appreciated that this may represent one or more individual cameras.

The road marking analyser further comprises a processor 46 and a memory 48 coupled to the processor via a memory bus 50. Image data from the camera 42 is provided to the processor via image data bus 52 and an optional control line 54 is provided between the processor and the light source 44, so that the processor can control and monitor characteristics of the light source 44. A speed meter 56 may optionally be provided to provide data relating to the speed of the vehicle 10 to the processor 46. The speed meter 56 may be integral to the vehicle 10 and/or in addition to the vehicles inbuilt speedometer. The road marking analyser 40 may additionally comprise a Global Positioning System (GPS) receiver 58 or similar device operable to receive information relating to the location of the road marking analyser 40 and associated vehicle 10. Location information from the GPS receiver 58 may be provided to the processor via location bus 60. Additionally, an input/output device 62 such as a wireless transceiver may be provided in the road marking analyser 40. The input/output device 62 may be arranged to transmit image data acquired by the camera(s) 42, location information from the GPS receiver 58 and/or speed data from the speed meter 56 to a remote location either in real time or at a later time. The input/output device 62 may receive queries from the remote location in response to which the processor may send data via the input/output device 62 to the remote location or another location. The input/output device 62 may also be operable to receive information concerning known road markings and their locations, such that the position of road markings in the image captured by the camera(s) can be predicted during analysis of the images, as will be described in more detail below.

For weave detection, the resolution of images captured by the camera may be chosen so as to reduce the processing requirement of captured road marking data whilst allowing an accurate identity and assessment of the position of road markings in collected images. As such, imaging equipment having a relatively low resolution may be used. For example, the road may be illuminated using a visible light or infra red laser or a plurality of visible light or infra red light emitting diodes (LEDs) and the reflection of light from the road detected by one or more of visible or infra red photodiodes. In some embodiments, however, where the vehicle weave detector 40 is used for analysing the condition of road markings as well as monitoring driver weave, a camera 42 or other imaging device of higher resolution may be used in order to provide the necessary detail to assess the condition of road markings.

During operation, the vehicle 10 travels along a road or carriageway 30. The processor 46 may signal to the light source 44 to provide illumination of the road beneath the vehicle 10. As described above the light source is preferably a scanning laser which provides a consistent illumination independent of natural light, enabling repeatable image properties to be obtained. Images are captured by the camera(s) 42 and provided to the processor 46 preferably in real time. At the same time as an image is received by the processor, the processor preferably also queries the speed meter 56 and GPS receiver 58 and receives a value of the vehicle speed of the vehicle 10 from the speed meter 56 such that the vertical scale of the image captured by the camera(s) 42 can be calculated, and GPS coordinates of the current location of the vehicle from the GPS receiver 58. This information may then be passed to the memory 48 for storage or transmitted in real time via the input/output device 62 to a remote location. Additionally or alternatively, images, speed and location information may be processed on board using the processor 46 in real time.

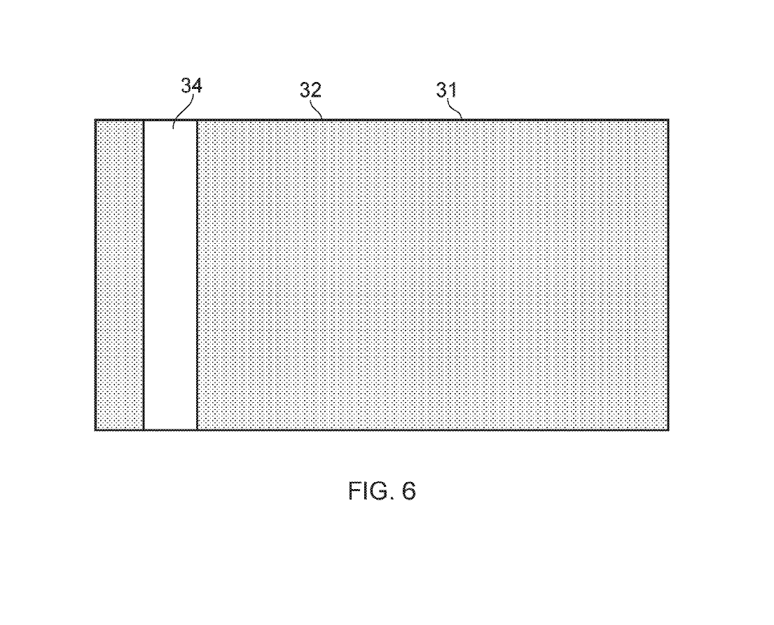

To detect weave of the vehicle 10, the position of road lines or other markings in images captured by the camera 42 may be determined in real time or in post processing using methods such as those described below with reference to FIGS. 6 to 8. The variation in the position of road markings in subsequent images over a time period may then be used to determine a measure of weave of the vehicle 10 relative to the road marking. This information may then be transmitted using the input/output device 62 to a remote location for analysis or stored in the memory 48 for future analysis or may be processed in real time, for example to provide feedback to a driver of an amount of weave of the vehicle 10.

Information concerning driver weave collected by the vehicle weave detector may be used to determine the quality of a person's driving. Such information may be used to analyse the state of a driver, which may include determining whether a driver is tired or intoxicated. Vehicle weave information may be used by develop a profile of a particular driver and his habits. Such information may be of particular value to insurance companies when assessing the safety of an insured driver and the risk of accident posed by that driver.

The vehicle weave detector 40 may also be used to determine the condition of road markings. Condition statistics generated from such analysis may then be used to determine the accuracy of the measurement of vehicle weave performed by the weave detector 40. For example, if the condition of the road marking being used to determine vehicle weave at a particular point in time or GPS location is poor, a lower weight may be given to associated weave measurements. In contrast, if the condition of the road marking is good then a higher weight may be given to measurements of weave gathered at that point. Condition statistics may also be used in conjunction with vehicle weave to determine the condition of a road surface. For example, weave due to a road imperfection such as pothole may coincide with instances of poor quality road markings. As such, instances of a high degree of weave and a poor quality road marking at a particular location may provide evidence of a road imperfection. Further investigations may then be performed either manually on site or by reviewing images of the road surface captured by the cameras of the weave detector 40. This becomes possible where a processing centre collects data from many vehicles. The road imperfection may itself be imaged and used to modify the operation of the weave detector.

A method of analysing captured images of road markings will now be described with reference to FIGS. 6 to 8. The skilled person will appreciate that such methods may be performed by the onboard processor 46 shown in FIG. 5 or alternatively by other means located in a different location. In either case, the methods may be performed in real time or at a later time depending on the embodiment in that particular instance. FIG. 6 shows a simplified schematic view of the image 31 captured in FIG. 3. The image 31 comprises a single white line 34 on a grey road surface 32.

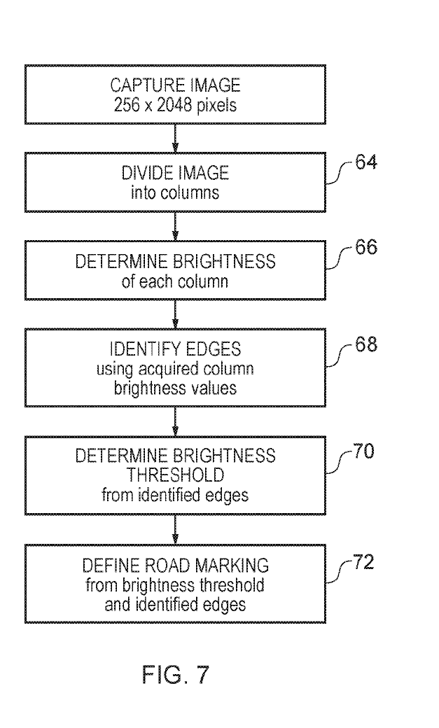

In an example embodiment, images may be processed in a 256 by 2048 pixel region of interest which corresponds to a surface region of approximately 0.25 meters long by 2 meters wide. It will however be appreciated that any pixel resolution may be used to correspond to any surface region size. For example where weave is to be detected relative to a road line, images may be processes in a smaller region, for example of 256×256 pixels corresponding to a 0.25×0.25 m square on the road surface. A method of processing the captured image 31 will now be described with reference to FIG. 7. At step 64, the captured image 31 is divided into columns which run in the direction parallel to the direction of travel of the vehicle. Thus because white (or other colour) road lines tend also to be orientated in the direction parallel to the direction of travel of a vehicle, the white line 34 also runs in the direction from top to bottom of the image 31. A value of the brightness of pixels in each column of the image is calculated at step 66. This value may, for example, be a mean of the value of brightness of pixels in each column. Columns having a high value of brightness relative to the dark road background suggest the presence of a road marking in those columns. Such regions may be identified at step 68 by detecting either a rise or fall in the brightness values at the edges of the region, the contrast in brightness representing edges of a road marking region. A rise in brightness values may represent the transition from road to white line 34. A fall in brightness values may represent the transition from white line 34 to road. Once line edges have been detected in the image 31, a threshold may be determined at step 70 from the bright pixels and edge area. This threshold may represent a brightness above which there is considered to be a road marking in a particular column of the image 31. At step 72, the region edges may be used to fully identify the road marking 34 within the image. Both edges of a portion of line may be identified by dark to light transitions. A positive identification may be verified when there is a sequence of bright values exceeding the threshold in each column between the detected edges of the line. Additionally or alternatively, stored data pertaining to the expected dimensions, such as width, of road markings may be used to verify that a line between the edges identified in the image represents a genuine road marking on the road. In which case, the brightness of each column of the image need not exceed a threshold. This may be useful where lines are of particularly bad quality.

When a region is identified using the above mentioned method, it is preferably only accepted as a valid road marking if its size is compatible with road marking widths and measurements according to standard and known road marking protocols.

Once the region has been accepted as a valid road marking, a condition statistic may be generated. This statistic may be based on the ratio of the number of bright pixels in the region relative to the total number of pixels in the region. The condition statistic may be generated based on the ratio of pixels above a threshold relative to the pixels below a threshold brightness. Where multiple regions are found such as in images where two or three white lines are identified, a condition statistic for each or all of the lines may be generated.

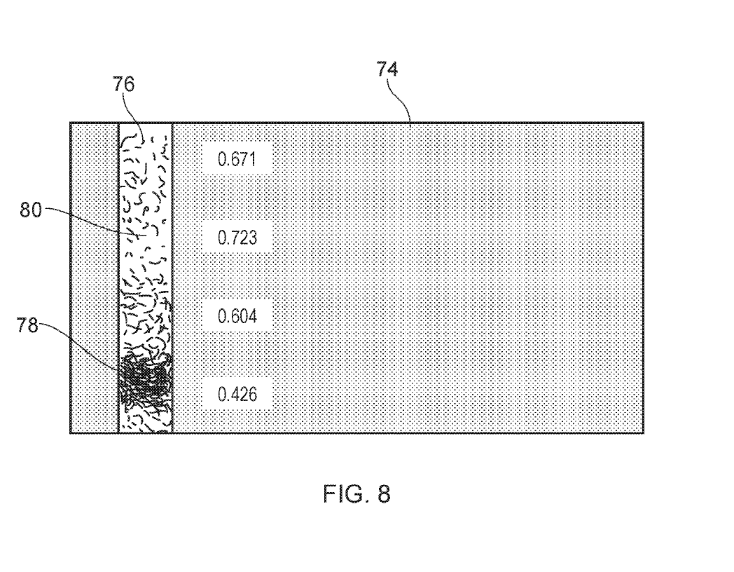

FIG. 8 shows an example image 74 of a white line 76 which has been analysed and for which condition statistics have been generated. As can be seen, more damaged areas such as the area denoted 78 are given a lower condition statistic of 0.426, which may mean that 42.6% of pixels within a that region have a brightness above a threshold brightness, relative to less damaged areas such as the area denoted 80, having a condition statistic value of 0.723, i.e. 72.3% of pixels within that area 80 have a brightness above the threshold. The estimate of how good a line is may be used to weight an estimate of vehicle weave. Having identified the position of, for example, a line at the edge of a road, a measurement of variation of the position of the line in the image as a function of time or distance can be generated as a measurement of vehicle weave.

The method described above divides the captured image 31 at step 64 into columns running in a direction parallel to the direction of travel of the vehicle. In addition, the captured image 31 may also at step 64 be divided into rows running in a direction perpendicular to the direction of travel. An equivalent process to that described with referenced to steps 66 and 68 of FIG. 7 may identify top and bottom edges of road markings in a captured image 31, for example, the leading and trailing edges of a single dash of a dashed white line. This information can be used to detect where a line starts and stops—a rise in brightness in successive rows may represent the start of a white line; a fall in brightness may represent the end of a white line. Based on the history of horizontal edges detected in images previously captured, the expectation of the presence of a line on the road may also be calculated, and the length of a suspected dashed white line may be calculated. This information may be used to further verify that the line identified in the captured image 31 is a genuine representation of a white line on the road by comparing its vertical dimensions (in a direction perpendicular to the direction of travel of the vehicle) with dimensions of standard road markings, stored in a database. Additionally or alternatively, where a trailing edge of a white line is detected (i.e. a fall in brightness in a successive rows) the system may stop looking for vertical line edges (rises/falls in brightness in successive columns of the image 31) until a leading edge is detected signalling the start of a new white line or the next dash in a dashed white line. Thus, the system can ascertain where a white line or other road marking is not present in a captured image in addition to determining where a white line is present.

It will be appreciated that other algorithms for providing a value of the relative condition of a road marking may be used.

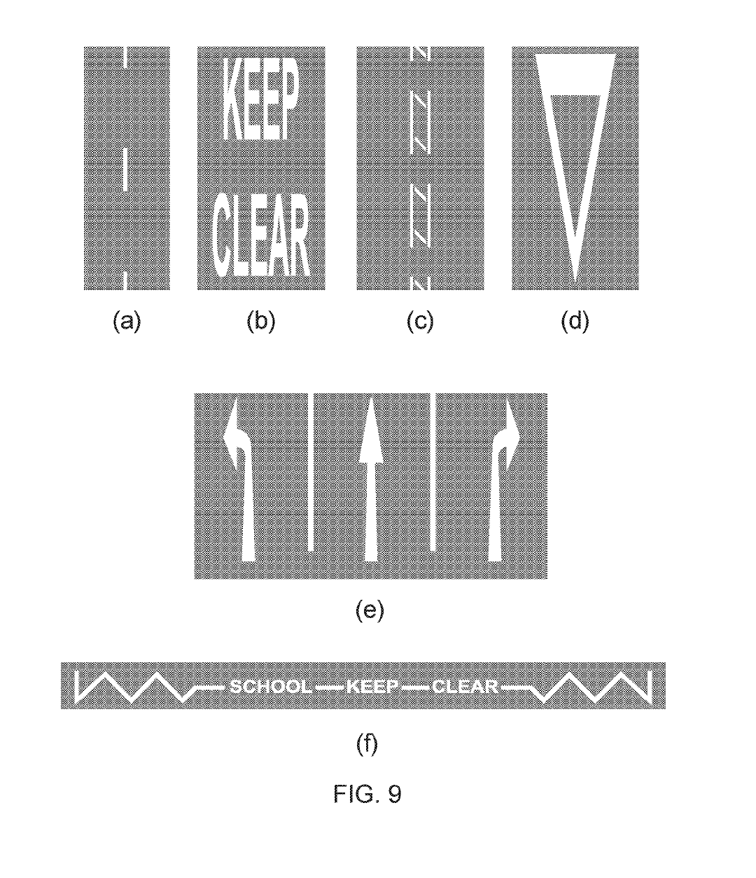

Whilst the above method is described in relation to identifying and analysing white lines, the condition of other road markings such as arrows, give way signs, and hatchings may also be assessed. Identification of other lines may also be used to inhibit a weave detector from giving a false indication of weave. FIG. 9 shows a small set of example road markings which may be captured using the road marking analyser and analysed to acquire condition information concerning their condition. Images captured by the one or more cameras 16, 18 may be analysed to identify areas of high threshold brightness relative to dark areas, in accordance with any suitable known image processing technique. Extracted “bright” regions may then be compared with images of known road markings.

Such known road markings may be stored in a database of “standard” road markings, which themselves may relate to a particular road network or country. This database may be local or remote to the road marking analyser or weave detector.

Extracted “bright” regions from acquired images may then be compared with the database of known road markings. Where a region is positively matched with a known road marking, the region may be deemed verified as genuine and the region in the image and image labelled as such. Pixel wise analysis of the condition of the road marking may then be performed as discussed above in relation to analysis of white lines.

To further verify the authenticity of an extracted bright region, location information received from the GPS receiver at the time that the image was captured may be used to, for example, verify that the matched road marking would have been present at the location at which the image was captured. For example, where an image was captured in the vicinity of a junction, the probability of a give way road marking such as that shown in FIG. 9(d), being present in the vicinity of that junction is high. As such, if a region of an image is identified as a give way sign during comparison with the database of known road markings, the vicinity of the image to a road junction provides further verification that such a match is correct.

Location information linked to captured images may also be used to predict where in a captured image a road marking may be located. For instance, if the image has been captured at a junction, there is a high chance of road markings to be present in the centre of the captured image, provided the camera(s) field of view is centred in the middle of the vehicle, since central markings such as give way or stop signs, arrows and hatchings are often present.

Additionally or alternatively, such location information may be used to generate a reduced subset of known road markings from the database of known road markings in order to provide a more efficient and faster comparison and search. For example, where location information denotes that an image has been captured near a school, a subset of known road markings may be generated comparing road markings usually associated with roads in the vicinity of schools, such as the keep clear signs show in FIGS. 9(b) and 9(f).

As noted before, in addition to analysing the condition of road markings, embodiments of road marking analysers described above may have alternative or additional application. For example, the road marking analyser described with reference to FIG. 5 may be used to monitor road weave of a driver of a vehicle. The position of road lines in images captured by the camera 42 may be determined in real time. The variation in the position of such a line over a time period may then be used to determine a measure of weave of a vehicle relative to the road line. This information may then be transmitted using the input/output device 62 to a remote location for analysis or stored in the memory 48 for future analysis. For this application, the resolution of images captured by the camera 42 need not be high since the condition of the line being monitored is not important. Accordingly, to reduce the processing requirement of captured road marking data, imaging equipment having a lower resolution may be used. For example, the road may be illuminated using a visible light or infra red laser or a plurality of visible light or infra red light emitting diodes (LEDs) and the reflection of light from the road detected by one or more of visible or infra red photodiodes. Where the road marking analyser of FIG. 5 is used both for analysing the condition of road markings and monitoring driver weave, a camera 42 or other imaging device of higher resolution may need to be used in order to provide the necessary detail to assess the condition of road markings, as described above.

Information concerning driver weave collected by the road marking analyser may be used to determine the quality of a persons driving. Such information may be used to analyse the state of a driver, which may include determining whether a driver is tired or intoxicated. Vehicle weave information may be used by develop a profile of a particular driver and his habits. Such information may be of particular value to insurance companies when assessing the safety of an insured driver and the risk of accident posed by that driver.

It will be appreciated that the terms “road” and “carriageway” used herein are used to describe any surface upon which markings may be placed. These include, but are not limited to, highways, motorways, race tracks, runways and airstrips. Roads may also include surfaces not limited to vehicle travel such as running tracks and any other surfaces which have markings applied to them.

1. A road marking condition analyser, comprising:
a light source arranged to illuminate a road, and
a camera directed or arranged to view vertically downward in a direction substantially perpendicular to a surface of the road and arranged to capture an image of the road and one or more road markings on the road; and
a processor arranged to process the image to determine a quality of the one or more road markings by detecting road markings in the image and forming measurements of luminance or brightness of the road markings in the image.

2. The road marking analyser as claimed in claim 1, wherein the light source is a scanning laser.

3. The road marking analyser as claimed in claim 1, in combination with a vehicle arranged to travel over the road.

4. The road marking analyser as claimed in claim 3, further comprising a device arranged to measure the speed of the vehicle over the road and wherein vehicle speed at the time at which the image is captured by the camera is stored in the memory.

5. The road marking analyser as claimed in claim 1, wherein the processor is further arranged to:
store the measurements of luminance or brightness of the markings in the memory.

6. The road marking analyser as claimed in claim 1, wherein detecting the one or more road markings in the captured image comprises:
dividing the image into a plurality of columns orientated parallel to the direction of travel of the road marking analyser;
calculating a value of luminance of each of the plurality of columns; and
identifying changes in the calculated values representing edges of the one or more road markings.

7. The road marking analyser as claimed in claim 6, wherein detecting the one or more road markings in the captured image further comprises:
dividing the image into a plurality of rows orientated perpendicular to the direction of travel of the road marking analyser;
calculating a value of luminance of each of the plurality of rows; and
identifying changes in the calculated values of luminance of each of the plurality of rows representing leading and/or trailing edges of the one or more road markings.

8. The road marking analyser as claimed in claim 5, wherein generating measurements of luminance or brightness of the one or more road markings comprises extracting a value of luminance or brightness from each pixel of the one or more road markings and comparing the value with a predetermined threshold.

9. The road marking analyser as claimed in claim 1, wherein the processor is adapted to:
compare the one or more detected road markings with a set of road markings stored in a database; and
determine one or more road marking types of the one or more road markings based on the comparison.

10. The road marking analyser as claimed in claim 1, further comprising:
a GPS receiver adapted to receive a location of the road marking analyser wherein, the processor compares the one or more detected road markings with a reduced subset of the set of road markings, the subset based on the location of the road marking analyser.

11. The road marking analyser according to claim 10, wherein the road marking analyser is adapted to predict the position of road markings in the image based on the location of the vehicle.

12. The road marking analyser according to claim 1, further comprising an input/output device arranged to transmit the captured image and/or information concerning vehicle location to a remote location.

13. The road marking analyser according to claim 1, wherein the light source is a visible light source or an infra-red light source and the camera is a visible light camera or an infra-red camera.

14. A method of analysing the condition of road markings, comprising:
while travelling along a road in a vehicle, illuminating one or more road markings;
capturing an image of the road with a camera where the image may contain one or more road markings, the camera being directed vertically downward substantially perpendicular to the surface of the road; and
storing the captured image of the one or more road markings for processing or processing the captured image to detect road marking in the image and to determine the quality of the one or more road markings.

15. The method of analysing road markings according to claim 14, further comprising:
generating measurements of condition of the one or more road markings in the captured image; and
storing the measurements.

16. The method of analysing road markings according to claim 14, wherein the detecting road markings in the image comprises:
dividing the image into a plurality of columns orientated parallel to the direction of travel of the vehicle;
calculating a value of luminance in each of the plurality of columns; and
identifying changes in the calculated values of luminance representative of edges of the one or more road markings.

17. The method of analysing road markings according to claim 16, wherein the detecting further comprises:
dividing the image into a plurality of rows orientated perpendicular to the direction of travel of the vehicle;
calculating a value of luminance in each of the plurality of rows; and
identifying changes in the calculated values of luminance in each of the plurality of rows representative of leading and/or trailing edges of the one or more road markings.

18. The method of analysing road markings according to claim 14, wherein the generating comprises:
extracting a value of brightness from each pixel of the one or more road markings and comparing the value with a predetermined threshold brightness.

19. The method of analysing road markings according to claim 14, further comprising:
comparing the one or more detected road markings with a set of known road markings stored in a database; and
determining one or more road marking types of the one or more road markings based on the comparison.

20. The method of analysing road markings according to claim 19, further comprising:
at a GPS receiver, receiving a vehicle location at the time at which the image is captured and storing the location.

21. The method of analysing road markings according to claim 20, further comprising:
predicting a reduced subset of the set of known road markings based on the vehicle location; and
comparing the one or more detected road markings with the reduced subset.

22. The method of analysing road markings according to claim 20, further comprising:
predicting a position of the one or more detected road markings in the image based on the vehicle location.

23. The method of analysing road markings according to claim 14, further comprising:
measuring a vehicle speed at the time at which the image is captured and storing the vehicle speed.

24. The method of analysing road markings according to claim 14, wherein the one or more road markings are illuminated by projecting a line of light on the road.

25. A vehicle weave detector, comprising:
a light source arranged to illuminate a road;
a detector directed vertically downward in a direction substantially perpendicular to a surface of the road and arranged to capture reflected light from the road; and
a processor arranged to:
generate images of the road from the reflected light;
detect a position of one or more road markings in each image; and
compare the position of the one or more road markings in subsequent images to generate a measure of weave of a vehicle relative to the road.

26. The vehicle weave detector as claimed in claim 25, wherein the light source is a scanning laser or a plurality of light emitting diodes.

27. The vehicle weave detector as claimed in claim 25, in combination with a vehicle arranged to travel over the road.

28. The vehicle weave detector as claimed in claim 27, further comprising a device arranged to measure the speed of the vehicle over the road and wherein vehicle speed at the time at which the reflected light is captured by the detector.

29. The vehicle weave detector as claimed in claim 25, wherein detecting the position of the one or more road markings includes:
dividing the image into a plurality of columns orientated parallel to the direction of travel of the vehicle;
calculating a value of luminance in each of the plurality of columns; and
identifying changes in the calculated values of luminance representative of edges of the one or more road markings.

30. The vehicle weave detector as claimed in claim 25, wherein comparing the position of the one or more road markings in subsequent images includes:
comparing the position of the edges of the one or more road markings in subsequent images to determine a relative displacement of the vehicle in a direction perpendicular to the direction of travel of the vehicle.

31. The vehicle weave detector as claimed in claim 25, further comprising a memory for storing the images and/or the generated measures of weave of the vehicle.

32. The vehicle weave detector as claimed in claim 25, wherein the vehicle weave detector further comprises an input/output device arranged to transmit the images and/or the measure of weave to a remote location.

33. The vehicle weave detector as claimed in claim 25, wherein the light source is a visible light source or an infra-red light source and the detector is a visible light detector or an infra-red detector.

34. The vehicle weave detector as claimed in claim 25, wherein the detector comprises a camera or one or more photodiodes.

35. A method of detecting vehicle weave, comprising:
while travelling along a road in a vehicle, illuminating a road;
capturing reflected light from the one or more road markings with a detector, the detector directed vertically downward in a direction substantially perpendicular to a surface of the road;
generating images of the road from the reflected light;
detecting a position of one or more road markings in each image; and
comparing the position of the one or more road markings in subsequent images to generate a measure of weave of a vehicle relative to the road.

36. The method as claimed in claim 35, wherein detecting the position of the one or more road markings includes:
dividing each image into a plurality of columns orientated parallel to the direction of travel of the vehicle;
calculating a value of luminance or brightness in each of the plurality of columns; and
identifying changes in the calculated values of luminance representative of edges of the one or more road markings.

37. A method as claimed in claim 35, wherein comparing the position of the one or more road markings in subsequent images includes:
comparing the position of the edges of the one or more road markings in subsequent images to determine a relative displacement of the vehicle in a direction perpendicular to the direction of travel of the vehicle.

38. A method as claimed in claim 35, further comprising storing the images and/or the generated measures of weave of the vehicle in a memory.

39. A method as claimed in claim 35, further comprising transmitting the images and/or the measure of weave to a remote location.
